(19) United States
(12) Patent Application Publication
(10) Pub. No.: US 2020/0396652 A1
(43) Pub. Date: Dec. 17, 2020

(54) METHOD, APPARATUS, COMPUTER PROGRAM PRODUCT AND COMPUTER PROGRAM FOR CONDITIONAL HANDOVER

(71) Applicant: NOKIA TECHNOLOGIES OY, Espoo (FI)

(72) Inventors: Guillaume DECARREAU, Munich (DE); Frank FREDERIKSEN, Klarup (DK); Irina-Mihaela BALAN, Munich (DE); Ingo VIERING, Munich (DE); Andreas LOBINGER, Grafing (DE)

(21) Appl. No.: 16/764,216

(22) PCT Filed: Nov. 16, 2017
(86) PCT No.: PCT/EP2017/079504

§ 371 Date: May 14, 2020

(51) Int. Cl. H04W 36/00; H04W 36/36

(52) U.S. Cl. CPC H04W 36/0055; H04W 36/36; H04W 36/0033

(57) ABSTRACT

The disclosure relates to a method at a user equipment comprising: receiving a first handover message associated with a first identifier associated with a first configuration; subsequently receiving a second handover message associated with a second identifier associated with a second configuration; and in dependence on if a current configuration is the first or the second configuration, causing the respective identifier associated with said first or said second configuration to be transmitted to a target base station.

### FIELD OF THE INVENTION

The invention relates to a method, an apparatus, a computer program product and a computer program.

### BACKGROUND

A communication system can be seen as a facility that enables communication between two or more devices such as user terminals, machine-like terminals, base stations and/or other nodes by providing carriers between the communication devices. A communication system can be provided for example by means of a communication network and one or more compatible communication devices. The communication may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless system at least a part of communications between at least two stations occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename Wi-Fi (or Wi-Fi). Wi-Fi is often used synonymously with WLAN. The wireless systems can be divided into cells, and are therefore often referred to as cellular systems.

A user can access a communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

A communication system and associated devices typically operate in accordance with a given standard or specification which sets out what the various entities associated with the system are permitted to do and how that should be achieved. Communication protocols and/or parameters which shall be used for the connection are also typically defined. An example of standardized communication system architectures is the long-term evolution (LTE) of the Universal Mobile Telecommunications System (UMTS) radio-access technology. The LTE has been and is being standardized by the 3rd Generation Partnership Project (3GPP). The LTE employs the Evolved Universal Terrestrial Radio Access Network (E-UTRAN) access. Further development of LTE are sometimes referred to as LTE Advanced (LTE-A). The current 3GPP standardization effort is directed to what is termed as the 5th Generation (5G) system. The 5G system is sometimes referred to as NR (new radio).

A UE may want to leave a first cell provided by a first node, and join a second cell provided by a second node. The process of the transferring the UE from the first cell to the second cell is known as UE handover. This process may also be known as UE hand over, or UE handoff.

### SUMMARY

According to a first aspect, there is provided a method comprising: receiving at a user equipment a first message associated with first information associated with a first configuration; subsequently receiving at said user equipment a second message associated with second information associated with a second configuration; and in dependence on if a current configuration is the first or the second configuration, causing the respective information associated with said first or said second configuration to be transmitted to a target base station.

The first information may be a first identifier.

The second information may be a second identifier.

The first and the second messages may be received from a base station.

The base station may be a source base station.

The first and the second messages may comprise handover messages.

The first and the second handover messages may comprise conditional handover messages.

The conditional handover messages may be one of: conditional handover common messages, conditional handover dedicated messages, and any other form of conditional handover messages.

The method may comprise, in response to determining that one or more conditions for conditional handover have been met, causing a message to be transmitted to said target base station with said respective information.

The message with said respective information may be configured to indicate that reconfiguration has been completed.

If said second configuration is not applied by said user device, said first information may be provided to said target base station.

If said second configuration is applied by said user device, said second information may be provided to said target base station.

The first information and the first configuration may be generated at a target base station.

The second information and the second configuration may be generated at a target base station.

According to a second aspect, there is provided a method comprising: receiving a message at a target base station responsive to a handover procedure being performed by a user equipment, said message comprising information indicating a configuration of said user equipment.

The method may further comprise: causing a first message associated with a first information associated with a first configuration to be transmitted to a source base station; and subsequently causing a second message associated with a second information associated with a second configuration to be transmitted to the source base station.

Receiving the message with the respective information may further comprise an indication that a reconfiguration has been completed by the user equipment.

The target base station may use the configuration associated with the respective identifier.

The method may further comprise causing a configuration request to be transmitted to a source base station said configuration associated with the information.

The method may further comprise receiving a configuration associated with one of a first information and a second information from the source base station.

The method may further comprise using a configuration associated with the respective said first or said second information.

The method may further comprise causing a reconfiguration message to be transmitted to the user equipment.

The first information may be a first identifier.

The second information may be a second identifier.

According to a third aspect there is provided a method comprising: causing a first message associated with first information associated with a first configuration to be transmitted to a user equipment; and subsequently causing a second message associated with second information associated with a second configuration to be transmitted to said user equipment.

The first message associated with the first information associated with the first configuration may be received from a target base station; and the second message associated with said second information associated with said second configuration may be received from the target base station.

The method may further comprise receiving an acknowledgment message from the user equipment.

At least one of said messages may comprise a user equipment configuration associated with an information.

A message may be caused to be transmitted to a target base station the message may comprise the user equipment configuration associated with the information.

The first information may be a first identifier.

The second information may be a second identifier.

According to a fourth aspect, there is provided an apparatus in a user device comprising at least one processor and at least one memory including a computer program code, the at least one memory and the computer program code configured to, with the at least one processor, cause the apparatus at least to: receive a first message associated with a first information associated with a first configuration; subsequently receive a second message associated with a second information associated with a second configuration; and in dependence on if a current configuration is the first or the second configuration, cause the respective information associated with said first or said second configuration to be transmitted to a target base station.

The first information may be a first identifier.

The second information may be a second identifier.

The first and the second messages may be received from a base station.

The base station may be a source base station.

The first and the second messages may comprise handover messages.

The first and the second handover messages may comprise conditional handover messages.

The conditional handover messages may be one of: conditional handover common messages, conditional handover dedicated messages, and any other form of conditional handover messages.

In response to determining that one or more conditions for conditional handover have been met, the at least one memory and the computer program code may be configured to, with the at least one processor to cause a message to be transmitted to said target base station with said respective information.

The message with said respective information may be configured to indicate that reconfiguration has been completed.

If said second configuration is not applied by said user device, said first information may be provided to said target base station.

If said second configuration is applied by said user device, said second information may be provided to said target base station.

The first information and the first configuration may be generated at a target base station.

The second information and the second configuration may be generated at a target base station.

According to a fifth aspect there is provided an apparatus in a target base station comprising at least one processor and at least one memory including a computer program code, the at least one memory and the computer program code configured to, with the at least one processor, cause the apparatus at least to: receive a message responsive to a handover procedure being performed by a user equipment, said message comprising information indicating a configuration of said user equipment.

The at least one memory and the computer program code may be configured to, with the at least one processor to cause a first message associated with a first information associated with a first configuration to be transmitted to a source base station; and subsequently cause a second message associated with a second information associated with a second configuration to be transmitted to the source base station.

The at least one memory and the computer program code may be configured to, with the at least one processor to receive the message with the respective information which may further comprise an indication that a reconfiguration has been completed by the user equipment.

The target base station may be configured to use the configuration associated with the respective identifier.

The at least one memory and the computer program code may be configured to, with the at least one processor to cause a configuration request to be transmitted to a source base station said configuration associated with the information.

The at least one memory and the computer program code may be configured to, with the at least one processor to receive a configuration associated with one of a first information and a second information from the source base station.

The at least one memory and the computer program code may be configured to, with the at least one processor to use a configuration associated with the respective said first or said second information.

The at least one memory and the computer program code may be configured to, with the at least one processor to cause a reconfiguration message to be transmitted to the user equipment.

The first information may be a first identifier.

The second information may be a second identifier.

According to a sixth aspect, there is provided an apparatus in a source base station comprising at least one processor and at least one memory including a computer program code, the at least one memory and the computer program code configured to, with the at least one processor, cause the apparatus at least to: cause a first message associated with a first information associated with a first configuration to be transmitted to a user equipment; and subsequently cause a second message associated with a second information associated with a second configuration to be transmitted to said user equipment.

The first message associated with the first information associated with the first configuration being received from a target base station; and the second message associated with said second information associated with said second configuration being received from the target base station.

The at least one memory and the computer program code may be configured to, with the at least one processor to receive an acknowledgment message from the user equipment.

The at least one memory and the computer program code may be configured to, with the at least one processor to receive a message from a target base station, the message may comprise a user equipment configuration associated with an information.

The at least one memory and the computer program code may be configured to, with the at least one processor to cause a message to be transmitted to a target base station the message may comprise the user equipment configuration associated with the information.

The first information may be a first identifier.

The second information may be a second identifier.

According to a seventh aspect, there is provided an to apparatus comprising: means for receiving at a user equipment a first message associated with a first information associated with a first configuration and subsequently receiving at said user equipment a second message associated with a second information associated with a second configuration; and in dependence on if a current configuration is the first or the second configuration, means for causing the respective information associated with said first or said second configuration to be transmitted to a target base station.

According to an eighth aspect, there is provided an apparatus comprising: means for receiving a message at a target base station responsive to a handover procedure being performed by a user equipment, said message comprising information indicating a configuration of said user equipment.

A computer program comprising program code means adapted to perform the method(s) may also be provided. The computer program may be stored and/or otherwise embodied by means of a carrier medium. The computer program may be provided on a non-transitory computer program carrying medium.

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF THE DRAWING

Some embodiments will now be described in further detail, by way of example only, with reference to the following examples and accompanying drawings, in which:

FIG. 1 schematically shows a communication system within which embodiments may be employed;

FIG. 2 schematically shows a communication device within which embodiments may be employed;

FIG. 3 schematically shows a control apparatus within which embodiments may be employed;

FIG. 4 schematically shows an example of a three entity network within which embodiments may be employed;

FIG. 5 shows a message flow of conditional handover-dedicated;

FIG. 6 shows a message flow of conditional handover-common;

FIG. 7 shows a message flow of conditional handover-dedicated within which some embodiments may be employed;

FIG. 8 shows a message flow of conditional handover-common within which some embodiments may be employed; and

FIG. 9 shows a method in a UE within which some embodiments may be employed.

### DETAILED DESCRIPTION OF THE DRAWINGS

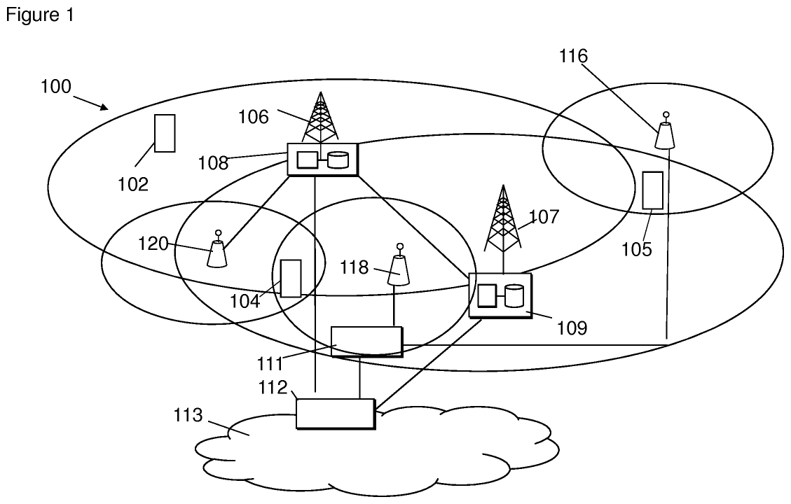

Before explaining in detail embodiments, certain general principles of a communication system, a mobile communication device and a control apparatus are briefly explained with reference to FIGS. 1 to 3 to assist in understanding the technology underlying the described invention.

In a wireless communication system 100, such as that shown in FIG. 1, wireless communication devices, for example, user equipments 102, 104, 105 are provided wireless access via at least one base station or similar wireless transmitting and/or receiving wireless infrastructure node or point. Such a node can be, for example, a base station or an eNodeB (eNB), or in a 5G system a Next Generation NodeB (gNB), or other wireless infrastructure node. These nodes will be generally referred to as base stations. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller. Other examples of radio access system comprise those provided by base stations of systems that are based on technologies such as 5G or new radio, wireless local area network (WLAN) and/or WiMax (Worldwide Interoperability for Microwave Access). A base station can provide coverage for an entire cell or similar radio service area.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

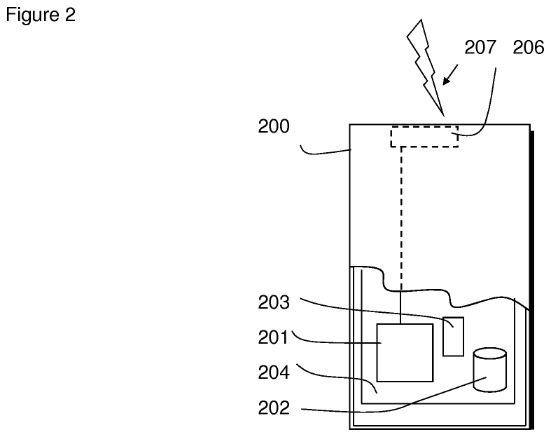

A possible wireless communication device will now be described in more detail with reference to FIG. 2 showing a schematic, partially sectioned view of a communication device 200. Such a communication device is often referred to as an endpoint device. An appropriate communication device may be provided by any device capable of sending and receiving radio signals.

A communication device may be for example a mobile device, that is, a device not fixed to a particular location, or it may be a stationary device. The communication device may need human interaction for communication, or may not need human interaction for communication.

The communication device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the wireless device.

A communication device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. Furthermore, a wireless communication device may comprise appropriate connectors (either wired or wireless) to other devices and/or for connecting external accessories. The communication devices 102, 104, 105 may access the communication system based on various access techniques.

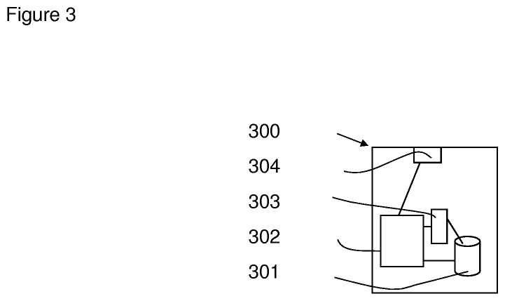

FIG. 3 shows an example of a control apparatus 300. The control apparatus may be integrated in a gNB. The control apparatus 300 can be arranged to provide control on communications in a service area of the system. The control apparatus 300 comprises at least one memory 301, at least one data processing unit 302, 303 and an input/output interface 304. Via the interface the control apparatus 300 can be coupled to a receiver and a transmitter of the gNB. The receiver and/or the transmitter may be implemented as a radio front end or a remote radio head. For example the control apparatus 300 can be configured to execute an appropriate software code to provide the control functions.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced NodeBs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Another example of a communications system is the 5G concept. Network architecture in 5G may be quite similar to that of the LTE-advanced. Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. 5G may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

In a traditional handover or basic handover (BHO), the process is triggered by a UE observing conditions that trigger a measurement report based on network configuration. The UE sends a measurement report. The report points to a particular cell (target cell), and typically, indicating that the neighbouring cell has a better signal quality than the serving cell (the cell currently providing network coverage to the UE). The source node (source node) controlling the source cell sends a message to the target node (Target NB) controlling the target cell for the handover preparation. This message includes the UE context. The context includes, for example, data radio bearers (DRBs) that are used by the UE, and the corresponding sublayer configuration, for example, packet data convergence protocol (PDCP). The target node replies with an acknowledgment which contains the radio resource control (RRC) configuration that the UE will need to use when it accesses the target cell. This RRC configuration may include the new configuration of DRBs (based on the UE context), but may also include radio configurations that should be used in target cell. The source cell sends the handover command to the UE. The UE then establishes a connection to the target cell, and applies the RRC configuration received in the handover command message. The target node may then indicate to the source node that the handover was successful, and the source node may release the resources allocated to the UE.

3GPP TS 36.300 section 10.1.2.1.1 describes a handover message flow.

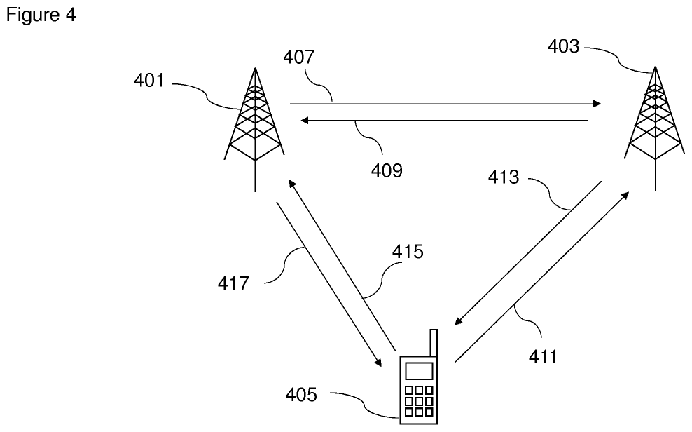

Reference will now be made to FIG. 4, which shows a user equipment (UE) 405, first base station (source node) 401 which provides a first cell (Source Cell), and a second base station (target node) 403 which provides a second cell (Target Cell). The source node 401 is able to send messages 417 to the UE 405 (for example a handover command and configuration), and the source node 401 is also able to send messages 407 to the target node 403 (for example a handover request). The UE 405 is able to send messages 417 to the source node 401 (for example a measurement report), and the UE 405 is also able to send messages 411 to the target node 403 (for example a configuration report). The target NB 403 is able to send messages 409 to the source node 401 (for example handover acknowledgment and configuration), and the target node 403 is also able to send messages 413 to the UE 405.

Conditional Handover (CHO) is a feature that is currently under consideration for next evolution of radio network systems, for example so called 5G or new radio (NR).

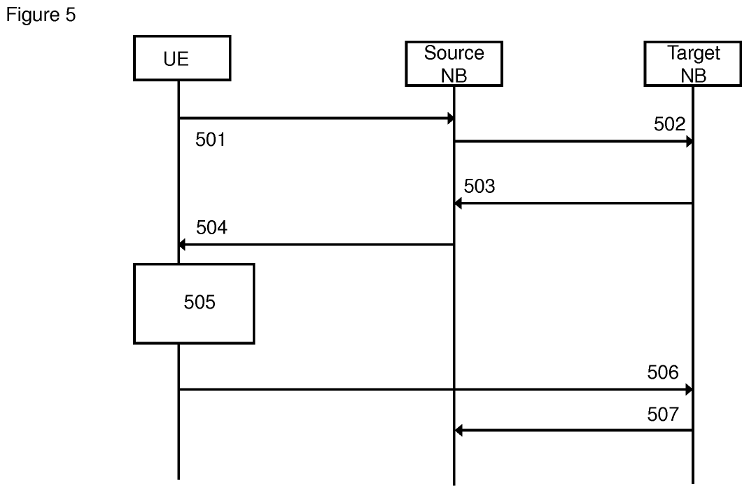

Reference will now be made to FIG. 5, which shows an implementation of Conditional Handover-Dedicated (CHO-D) between a user equipment (UE), source node base (source node), and target node base (target node). In the case of Conditional Handover (CHO), there are some differences to basic handover (BHO).

The first three steps of Conditional Handover-Dedicated (CHO-D) and Basic Handover (BHO) may be the same except that the CHO acknowledgement (ACK) and the HO command contain additional information as discussed below.

In step 501, the UE sends a measurement report to the source node indicating that a neighbouring cell has better signal quality than the cell which it is currently being served by.

In step 502, the serving NB sends a CHO-D request to the target node which controls the target cell. This message contains a UE context of the UE it received the measurement report for.

In step 503, the target NB replies with a CHO acknowledgement. This message includes the RRC parameters, or RRC configuration that the UE may use at the target cell. The RRC configuration comprises one or more additional condition(s) for the UE, as discussed below.

Step 504 is where conditional handover-dedicated (CHO-D) diverges from basic handover (BHO). In step 504, the source node sends the UE an RRC reconfiguration message via the source Cell. The RRC reconfiguration message includes the RRC target configuration delivered by the target cell to the source cell in step 503. The UE then waits for the one or more condition(s) for HO to be satisfied, and/or fulfilled.

In step 505, the conditions for CHO are triggered. Thus one or more condition(s) for HO may be fulfilled in the UE. Such a condition may be for example that the target cell quality is above a threshold, which may be different from the threshold which triggered the CHO-D request. Alternatively or additionally the condition may be that the serving cell signal quality (source cell) has fallen below a threshold. Any such thresholds may be pre-determined values or the thresholds may be determined dynamically.

In step 506, RRC reconfiguration is completed. The UE connects to the target cell, and sends an RRC reconfiguration complete message to the target node via the target cell.

In step 507, the HO is completed. The target node sends the source node an indication that the HO was successful, and is complete.

As described above, in case of CHO-D, the UE may not immediately perform a random-access procedure via the random access channel (RACH) to the target cell after receiving the handover command, but waits for at least one condition(s) to be fulfilled. As discussed above one such condition may be, for example, that the quality of the target cell is above a given threshold.

An advantage of the CHO is that the UE can quickly perform the HO when at least one radio condition(s) is met, as some of the preparation messages between the source cell and the target cell have already been exchanged.

Another type of CHO is possible. In this second case, the UE does not receive a dedicated configuration for the target node: instead the UE will use common channels and common RACH configuration to access the target node. This scheme will be called Conditional Handover Common (CHO-C).

When a least one condition(s) is met at the UE, for example, when the target cell signal quality is above a threshold value, the UE autonomously performs RACH access with the target node. The target node then recovers the UE context from the source node and reconfigures the UE.

Alternatively the UE may send a measurement report and give the network the chance to initiate a BHO. This may be initiated by waiting a certain amount of time for a HO command. When the timer expires and if no HO command has been received, CHO-C may be initiated.

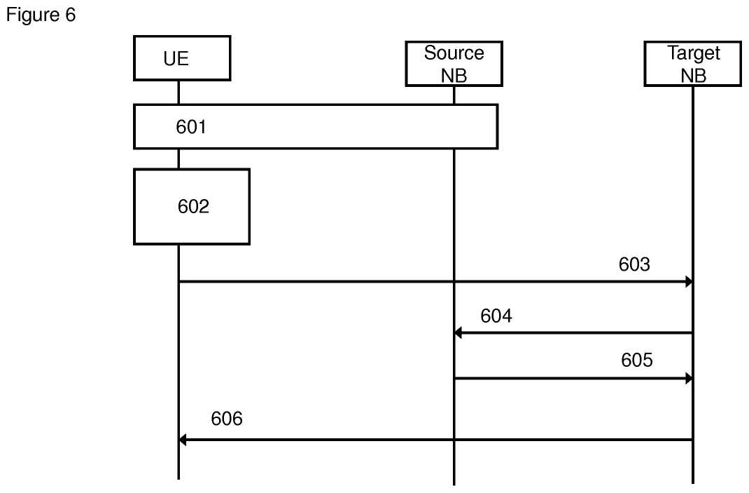

Reference is now made to FIG. 6 which shows an example message flow for CHO-C. In step 501, the UE is configured for CHO-C. The UE is configured for CHO-C by messaging between the UE and the source node. However the target cell does not need to be pre-configured, and as such no messages are sent to the target node.

In step 602, conditions for CHO are triggered. The at least one condition for HO is satisfied and/or fulfilled at the UE. For example, the at least one condition to be satisfied may be that the target cell quality is above a threshold.

In step 603, a RRC re-establishment request is sent from the UE to the target node. The UE may connect to the target cell, and send an RRC re-establishment request message to the target node.

In step 604, UE context request is sent for the target node to the source node. The target node may send a message to the source node requesting the UE context information of the UE which has connected to the target cell.

In step 605, a UE context response is sent. The source node sends the requested UE context information to the target node.

In step 606, a RRC reconfiguration message is sent. The target node sends the RRC reconfiguration message to the UE in order to apply the new configuration.

In relation to Conditional Handover-Common (CHO-C it has been proposed that in some cases the UE may perform an RRC Re-establishment in the target cell.

For cells with a low likelihood of handover, the minimum information may be included in the conditional handover command, for example, target cell ID, and/or handover condition. The UE may need to send the connection re-establishment request to the target node to rebuild the connection. Upon the reception of the connection re-establishment request from the UE, the target node may re-establish the connection with the UE context stored.

It has also been proposed to extend the T312 concept, which is well-known in LTE, by starting T312 even if T310 is not running. This would also lead to CHO-C behaviour. In T310 a timer triggers Radio Link Failure. The timer is started when the UE detects a loss of synchronisation in the physical layer of the network. At the expiry of the timer, the UE tries to reconnect with any suitable cell by initiating a connection re-establishment procedure. T312 has been introduced for high speed UE in small cells. The UE starts a timer when sending a measurement report whilst 1310 is running. It is allowed to initiate initiating a connection re-establishment procedure at the expiry of the timer, which happen before the expiry of T312. Reference on T310 and T312 can be found in 36.331 section 7.3.1.

In both the cases of CHO-C, and CHO-D, after being configured for CHO, the UE is allowed to leave the source cell and connect to the target cell at any moment but can also receive messages, including reconfiguration messages, from the source cell.

In the case of CHO-D, in FIG. 5, the configuration of the UE may change between step 504 and step 505. The network may send an RRC configuration message. The configuration of the UE may change, for example, if a voice call is terminated or for other reasons. The network then de-configures the associated DRBs in the case of the voice call termination option.

The target node should be aware of changes in UE. If there is a mismatch in the configuration between UE and the target cell, this results in a call drop because the UE will not be able to apply the message from the target node.

The source NB may reconfigure the UE first and subsequently notify the target NB. The target node may then send another reply message to the source node. A new HO message may then be sent to the UE. However, if the UE performs the handover to the target node before all the handover messages have been received, there may be a configuration mismatch between the UE and the target node. As discussed above, such a mismatch in configuration may result in a call drop on handover.

Furthermore, in normal conditions, the UE may send an acknowledgement (ACK) message indicating that it has received and applied the message. However, in the case of CHO-D, the UE may not send the ACK, even if the UE has applied the reconfiguration. For example, if the current HO command is not acknowledged, the UE may immediately transfer to the target cell. This may result in the source and target cell not knowing the exact UE configuration.

Although this issue has been described by way of example in CHO-D, the issue occurs in case of CHO-C. In FIG. 6, between steps 601 and 602, the UE may receive a reconfiguration message and the UE configuration may change. The source NB may not know whether the UE has implemented the latest configuration (made in response to the reconfiguration message) when the handover is performed without sending an ACK for the reconfiguration message. Therefore, when the target node requests the UE context, the source node may not know whether it should send the first configuration that applied before the reconfiguration message or the second configuration that applied after the reconfiguration message.

Some embodiments described may provide a validation/verification mechanism for conditional handover. The validation/verification mechanism may in some embodiments be based on transaction identifiers (TIs), which ensure that potential error cases are discovered, and/or reduced, and/or eliminated. The transaction identifiers are targeted to be implemented as specific transaction identifiers that are introduced in the RRC messages which may be used for the CHO operation. The transaction identifiers may also be implemented in other handover operations. Through this mechanism it is possible to match and validate the configurations between the three nodes that are involved in the CHO, the source node 401, the target node 403, and the UE 405.

CHO-D

Some embodiments will now be described for the case of conditional handover-dedicated (CHO-D). When the target node generates a (first) reconfiguration message that will be delivered to the UE for the handover (HO), the target node may associate the reconfiguration message with a HO transaction identifier (for example TI #1).

This handover (HO) transaction identifier (TI #1) may then be included in a HO command message to the UE. This message may be an RRC reconfiguration message. The UE may then store the HO transaction identifier (TI #1) associated with the message.

When source node sends a further configuration message to reconfigure the UE (RRC reconfiguration message) before execution of the handover. The source node may generate and send a new handover (HO) transaction identifier (TI #2) associated with the new (second) configuration message.

The UE may store the new HO transaction identifier (TI #2) associated with the message when the reconfiguration is applied to the UE.

If the reconfiguration is not applied to the UE, for example due to a lack of time, or if the second message is not received by the UE, the UE does not store the new HO transaction identifier (TI #2) associated with the second configuration message.

When the UE performs CHO-D, the UE includes the HO transaction identifier of the latest reconfiguration that was successfully applied by the UE. For example, the first configuration associated with TI #1 for the first configuration, or the second configuration associated with TI #2.

The target node then compares the HO transaction identifier received from the UE to the HO transaction identifiers that were received by the target node from the source node. The target node then uses the stored configuration associated with the HO transaction identifier received from the UE (i.e. the first configuration or the second configuration depending on the transaction identifier received).

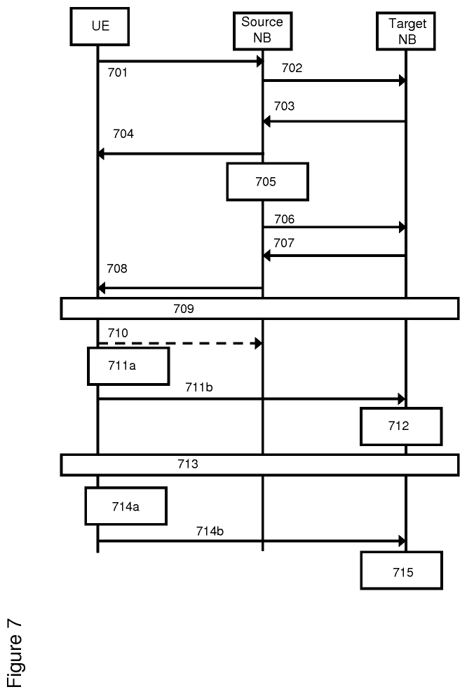

Some embodiments will now be described in more detail with reference to FIG. 7 which shows an example implementation of some embodiments for CHO-D.

In step 701, the UE may send a measurement report indicating that a neighbouring cell has a good signal quality, which may be better than the signal quality which it is currently experiencing from the source node (serving NB).

In step 702, the source node sends a CHO-D request to the target node which is controlling the Target cell. This message contains the UE context.

In step 703, the target node may reply with a CHO acknowledgement to the source node. This message may include RRC parameters that the UE may use at the target node. The message may also include a handover transaction identifier (HO Tr. ID) for example #1.

In step 704, the source node sends a message to the UE via the source cell. This message may be an RRC reconfiguration message, which may include an RRC target configuration that was delivered by the target node in step 703. The message may also include the handover transaction identifier (HO Tr. ID) #1. The UE may then wait for the conditions for HO to be fulfilled and/or satisfied.

In step 705, the source node may need to change the UE configuration. For example, a service e.g. a voice call may have ended, or alternatively or additionally a new service may have started and/or the like. This change may for example include a change in the DRB configuration.

In step 706, the source node may send a new CHO-D request to the target node, where the target node controls the target cell. This message may contain a new UE context that needs to be implemented on the UE for a successful handover (i.e. to avoid a mismatch in configuration between the UE and the target node on handover, and hence a potential call drop).

In step 707, the target node replies to the source node with a message that may include a CHO acknowledgement. The message may also include new RRC parameters that the UE may use at the target cell as well as a new handover (HO) transaction identifier (Tr. ID), for example #2.

In step 708, the source node sends a message to the UE via the source cell. The message may include an RRC Reconfiguration message. The message may also include the new RRC target configuration received at the source node from the target node in step 707. The message may also include the new handover (HO) transaction identifier (Tr. ID) #2.

An example of a first CHO-D scenario relating to some embodiments will now be described with reference to steps 709 to Step 712. In the first scenario, in step 709 the UE may implement the reconfiguration, (i.e. the new RRC target configuration).

In step 710, the UE may or may not send an acknowledgement (ACK) of the message received in step 708.

In step 711a, the conditions for handover are fulfilled and/or satisfied and the UE connects to the target cell. In step 711b, the UE may send a message to the target node. The message may contain a notification that the RRC reconfiguration is complete. The message may also include the handover (HO) transaction identifier (Tr. ID) #2 (i.e. the target node may be notified that the UE is configured to the new RRC configuration associated with handover transaction identifier (Tr. ID) #2).

In step 712, the target node may use the UE context associated with handover (HO) transaction identifier (Tr. ID) #2 for handling the UE. Thus, both the UE and the target node are using the same matching second RRC configuration (context) associated with transaction identifier (Tr. ID) #2.

An example of a second CHO-D scenario relating to some embodiments will now be described with reference to steps 713 to Step 715. In step 713, the UE may not implement the second RRC reconfiguration associated with handover transaction identifier (Tr. ID) #2 (the new RRC target configuration).

In step 714a, the conditions for CHO-D are fulfilled and/or satisfied. In step 714b the UE may connect to the target node (target cell). The UE may also send a message to notify the target node that the RRC Reconfiguration is complete. The message may also include the handover (HO) transaction identifier (Tr. ID) #1 (i.e. the target node is notified that the UE is configured to the RRC configuration associated with handover transaction identifier (Tr. ID) #1).

In step 715, the target node may use the UE context associated with the handover (HO) transaction identifier (Tr. ID) #1 for handling the UE. Thus, both the UE and the target node are using the same matching first RRC configuration (context) associated with handover transaction identifier (Tr. ID) #1.

The target node may also give to the UE a new RACH preamble to use. This may be known if the UE has implemented the RRC reconfiguration

CHO-C

Some embodiments will now be described for the case of conditional handover-common (CHO-C). When the UE is configured for CHO-C by the source node with an RRC reconfiguration message, the source node may store the RRC transaction identifier (for example TI #1) associated with the message and the corresponding UE context. The UE may also store the RRC transaction identifier (for example TI #1) associated with the message.

When the source node sends another message to reconfigure the UE (RRC reconfiguration message) before the UE has left the source cell, the source node may store the RRC transaction identifier (for example TI #2) associated with the message and the corresponding UE context. The UE may also store the RRC transaction identifier (for example TI #2) associated with the message as well, when the reconfiguration is applied. If the reconfiguration may not be applied, for example due to a lack of time, or if the message has not been received, UE does not store the transaction identifier (for example TI #2) associated with the message.

When the UE performs CHO-C, it may include the RRC transaction identifier of the last reconfiguration that was successfully applied by the UE for example either TI #1, or TI #2.

The target node may then request the corresponding UE context from the source NB using the RRC transaction identifier delivered by the UE. For example, if the target node received TI #1 from the UE, the target node may request the UE context associated with TI #1 from the source node, and if the target node has received TI #2 from the UE, the target node may request the UE context associated with TI #2 form the source node. The source NB may then deliver the UE context associated with the corresponding TI to the target cell.

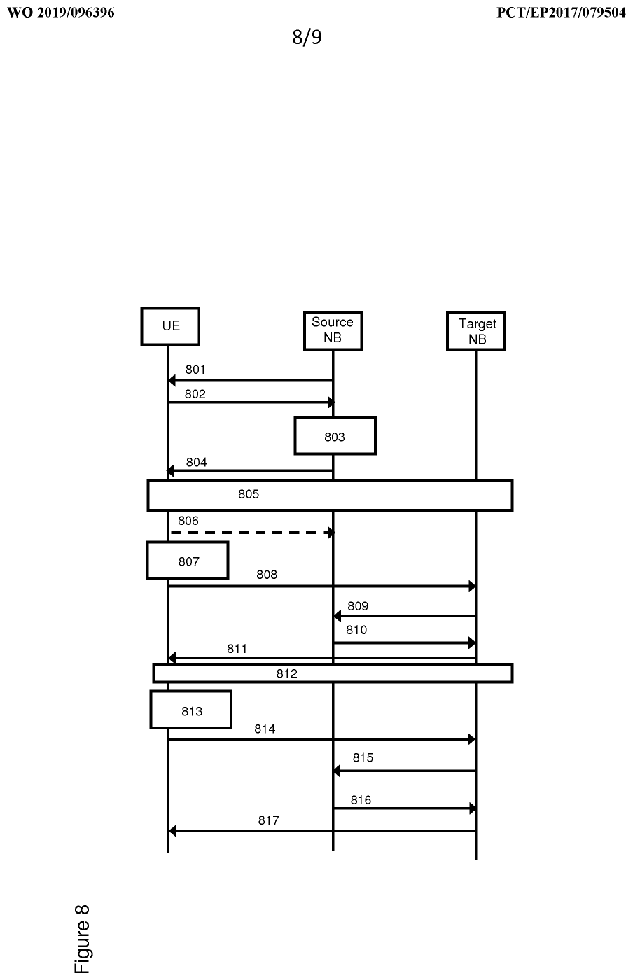

Some embodiments will now be described in more detail with reference to FIG. 8 which shows an example implementation of some embodiments for CHO-C.

In step 801, the UE receives a message from the source node. The message may include a (first) RRC reconfiguration associated with a transaction identifier (Tr. IDA for example #1. This RRC reconfiguration may configure the UE for CHO-C. The target node (target cell) may not need to be pre-configured.

In step 802, the UE may send an acknowledgement (ACK) message to the source node. The ACK message may inform the source node that the UE has been successfully configured to CHO-C.

In step 803, the source node (source cell) may need to change the UE configuration. For example, a service e.g. a voice call may have ended, or alternatively or additionally a new service may have started. Of course the UE configuration may be changed for any suitable reason. The change may include, for example, a change in the DRB configuration.

In step 804, the source node sends a message to the UE, because the UE may need to be re-configured for CHO-C. The message may include a new (second) RRC reconfiguration associated with an RRC transaction identifier (RRC Tr. ID), for example #2.

An example of a first CHO-C scenario relating to some embodiments will now be described with reference to steps 805 to Step 811. In step 805, the UE may apply the new RRC reconfiguration received by the UE in step 804.

In step 806, the UE may or may not send an acknowledgement (ACK) message to the source node.

In step 807, the UE conditions for CHO-C may be fulfilled and/or satisfied.

In step 808, the UE may connect to the target node (target cell). The UE may also send a message to the target node. The message may include an RRC re-establishment request associated with an RRC transaction identifier (RRC Tr. ID) #2. The message may also include the RRC transition identifier (RRC Tr. ID) #2.

In step 809, the target node may send a message to source node. The message may include a request for the UE context associated with RRC transaction identifier (RRC Tr. ID) #2.

In step 810, the source node sends a message to the target node. The message may include the UE context corresponding to the RRC transaction identifier (Tr. ID) #2.

In step 811, the target node sends a message to the UE. The message may include an RRC reconfiguration for the UE to apply a new configuration.

An example of a second CHO-C scenario relating to some embodiments will now be described with reference to steps 812 to Step 817. In step 812 the UE may not apply the new (second) RRC reconfiguration received by the UE in step 804.

In step 813, the UE conditions for CHO-C may be fulfilled and/or satisfied.

In step 814, the UE may connect to the target node (target cell). The UE may also send a message to the target node. The message may include an RRC Re-establishment Request associated with an RRC transaction identifier (Tr. ID) #1. The message may also include the RRC transition identifier (RRC Tr. ID) #1.

In step 815, the target node may send a message to source NB. The message may include a request for the UE context associated with RRC transaction identifier (Tr. ID) #1.

In step 816, the source node may send a message to the target node. The message may contain the UE context corresponding to RCC transaction identifier (Tr. ID) #1.

In step 817, the target node may send a message to the UE. The message may include and/or contain an RRC reconfiguration message to apply the new RRC configuration

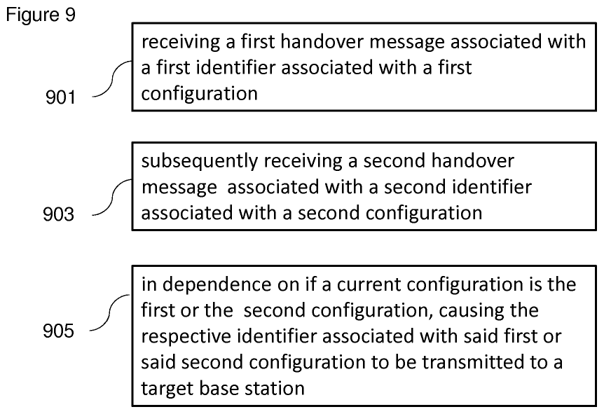

Reference will now be made with reference to FIG. 9 which shows a method in a UE within which some embodiments may be employed. In step 901, the UE receives a first handover message associated with a first identifier associated with a first. In step 903, the UE subsequently receives a second handover message associated with a second identifier associated with a second configuration. In step 905, in dependence on if a current configuration is the first or the second configuration, causing the respective identifier associated with said first or said second configuration to be transmitted to a target base station.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptions may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method, comprising:
receiving at a user equipment a first message associated with first information associated with a first configuration;
subsequently receiving at said user equipment a second message associated with second information associated with a second configuration; and
in dependence on if a current configuration is the first or the second configuration, causing the respective information associated with said first or said second configuration to be transmitted to a target base station.

2. (canceled)

3. (canceled)

4. The method as claimed in claim 1, wherein said first and second messages are received from a source base station.

5. (canceled)

6. The method as claimed in claim 1, wherein said first and second messages comprise conditional handover messages.

7. The method as claimed in claim 1, wherein said conditional handover messages are one of: conditional handover common messages, conditional handover dedicated messages, and any other form of conditional handover messages.

8. The method as claimed in claim 1, in response to determining that one or more conditions for conditional handover have been met, causing a message to be transmitted to said target base station with said respective information.

9. The method as claimed in claim 1, wherein said message with said respective information is configured to indicate that reconfiguration has been completed.

10. The method as claimed in claim 1, wherein if said second configuration is not applied by said user device, said first information is provided to said target base station.

11. The method as claimed in claim 1, wherein if said second configuration is applied by said user device, said second information is provided to said target base station.

12. The method as claimed in claim 1, wherein at least one of said first information and said first configuration are generated at said target base station.

13. The method as claimed in claim 1, wherein at least one of said second information and said second configuration are generated at said target base station.

14. A method, comprising:
receiving a message at a target base station responsive to a handover procedure being performed by a user equipment, said message comprising information indicating a configuration of said user equipment.

15. The method as claimed in claim 14, further comprising:
causing a first message associated with first information associated with first configuration to be transmitted to a source base station; and
subsequently causing a second message associated with second information associated with a second configuration to be transmitted to the source base station.

16. The method as claimed in claim 14, wherein receiving said message with said respective information further comprises an indication that a reconfiguration has been completed by the user equipment.

17. The method as claimed in claim 14, wherein said target base station uses the configuration associated with the respective identifier.

18. The method as claimed in claim 14, wherein said method further comprises causing a configuration request to be transmitted to a source base station said configuration associated with said information.

19. The method as claimed in claim 18, wherein said method further comprises receiving a configuration associated with one of first information and second information from the source base station.

20. The method as claimed in claim 19, wherein said method further comprises using a configuration associated with the respective said first or said second information.

21. The method as claimed in claim 20, wherein said method further comprises causing a reconfiguration message to be transmitted to the user equipment.

22. (canceled)

23. (canceled)

24. An apparatus in a user device, said apparatus comprising:
at least one processor; and
at least one memory including a computer program code;
the at least one memory and the computer program code configured to, with the at least one processor, cause the apparatus at least to:
receive a first message associated with a first information associated with a first configuration;
subsequently receive a second message associated with a second information associated with a second configuration; and
in dependence on if a current configuration is the first or the second configuration, cause the respective information associated with said first or said second configuration to be transmitted to a target base station.

25. (canceled)

26. An apparatus in a target base station, said apparatus comprising:
at least one processor; and
at least one memory including a computer program code;
the at least one memory and the computer program code configured to, with the at least one processor, cause the apparatus at least to:
receive a message responsive to a handover procedure being performed by a user equipment, said message comprising information indicating a configuration of said user equipment.
